(19) United States
(12) Patent Application Publication
(10) Pub. No.: US 2005/0241680 A1
(43) Pub. Date: Nov. 3, 2005

(54) Dishwasher

(75) Inventor: Hee Seok Noh, Pyeongtaek-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/033,844

(22) Filed: Jan. 13, 2005

(30) Foreign Application Priority Data
May 3, 2004 (KR) P2004-30942

(51) Int. Cl. B08B 7/04

(52) U.S. Cl. 134/56 D; 134/58 D; 134/198

(57) ABSTRACT

There is provided a mechanism for supporting a duct in an inside of a dishwasher. The dishwasher includes a housing, a tub, a nozzle, a duct, and a bracket. The nozzle is provided to an inside of the tub to spray washing water to dishes. The duct is extended along the inside of the tub to guide the washing water to the nozzle. The bracket is attached to the tub to support the duct.

This application claims the benefit of the Korean Application No. P2004-30942 filed on May 3, 2004 which is hereby incorporated by reference.

### BACKGROUND OF THE INVENTION

1. Field of the Invention

The present invention relates to a dishwasher, and more particularly, to a mechanism for supporting a duct that guides washing water to a nozzle.

2. Discussion of the Related Art

Generally, a dishwasher removes impurities that remain on dishes using washing water sprayed from a washing water spraying unit provided therein.

FIG. 1 is a schematic, perspective view of an inside of a tub in a general dishwasher.

The general dishwasher 10 includes: a tub 11 installed in an inside of a housing; a rail 14 installed horizontally to an inside of the tub 11, for mounting a rack that receives dishes therein; and a pair of rail rollers 15 formed at up and down of the rail 14, for moving the rail 14 back and forth. Further, the tub 11 has a nozzle 13 for spraying washing water in its inside and has, on its inner surface, a duct 12 for guiding the washing water to the nozzle 13, extended from a pump (not shown) up to the nozzle 13.

Function and operation of the dishwasher 10 will be briefly descried.

First, a user puts dishes into an upper and a lower racks (not shown) and pushes the racks into an inside of the washing tub. Then, the rail 14 is moved to a back of the tub 11 by the rail rollers 15 and simultaneously the racks are received in an inside of the tub 11. After that, a user closes a door and operates the dishwasher 10. In operation, washing water flows into a lower side of the tub 11 and an inside of a sump (not shown) and a washing pump connected with the sump is operated, so that the washing water moves along the duct 12. Further, the washing water is sprayed to the dishes through the nozzle 13 connected with the duct 12.

In the above-described general dishwasher, the duct 12 connects the pump with the nozzle 13 without being fixed to an inner surface of the tub 11. Thus, the duct 12 might shake while the dishwasher operates or moves and a noise or a malfunction may be generated.

### SUMMARY OF THE INVENTION

Accordingly, the present invention is directed to a dishwasher that substantially obviates one or more problems due to limitations and disadvantages of the related art.

An object of the present invention is to provide a dishwasher capable of firmly holing a duct that guides washing water.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a dishwasher, which includes: a housing; a tub installed to an inside of the housing, for receiving dishes to be washed; nozzles provided to an inside of the tub, for spraying washing water to the dishes; a duct extended along an inner surface of the tub, for guiding the washing water up to the nozzles; and a bracket attached to the tub, for supporting the duct.

The bracket supports a vertical portion of the duct extended along an inner surface of a lateral wall of the tub and thus is attached to an inner surface of a wall of the duct.

The bracket has at least one flange coupled to the duct and the flange is coupled to a side portion of the duct. The duct has a projection engaged with the flange and the flange has an opening into which the projection is fitted.

Further, the dishwasher further includes a recess formed on the tub, for receiving the duct. The recess includes: a first recess formed on a wall portion of the tub, for receiving a vertical portion of the duct; and a second recess formed on a bottom of the tub, for receiving a horizontal portion of the duct.

The bracket is installed in an inside of the recess and the duct is not protruded from the recess.

According to the present invention, the duct is stably supported in an inside of the tube without being shaken.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic, perspective view illustrating an inside of a tub in a general dishwasher;

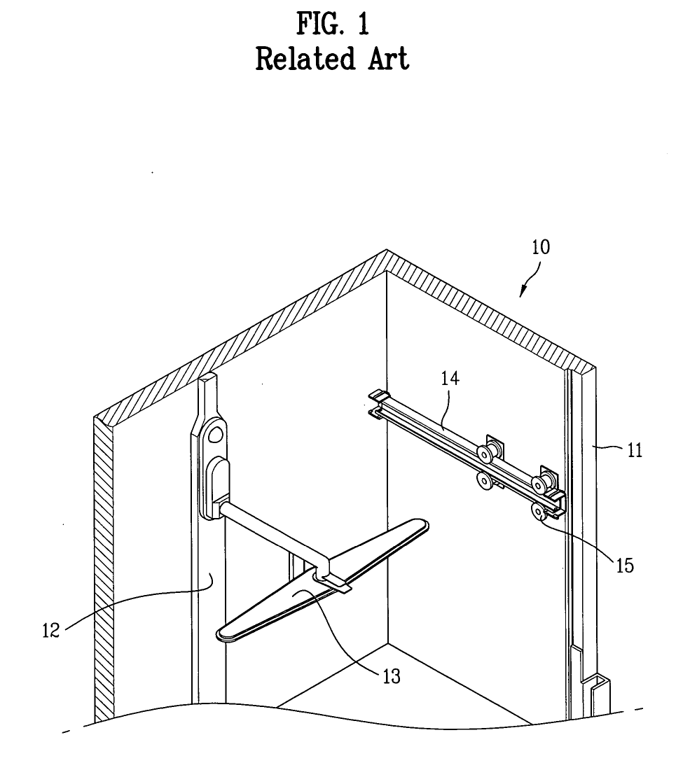

FIG. 2 is a cross-sectional view of a dishwasher according to the present invention;

FIG. 3 is a schematic, perspective view illustrating an inside of a tub in a general dishwasher according to the present invention; and

FIG. 4 is a partial, perspective view illustrating a duct mounted on a bracket in a dishwasher according to the present invention.

### DETAILED DESCRIPTION OF THE INVENTION

Reference will now be made in detail to the preferred embodiments of the present invention, examples of which are illustrated in the accompanying drawings.

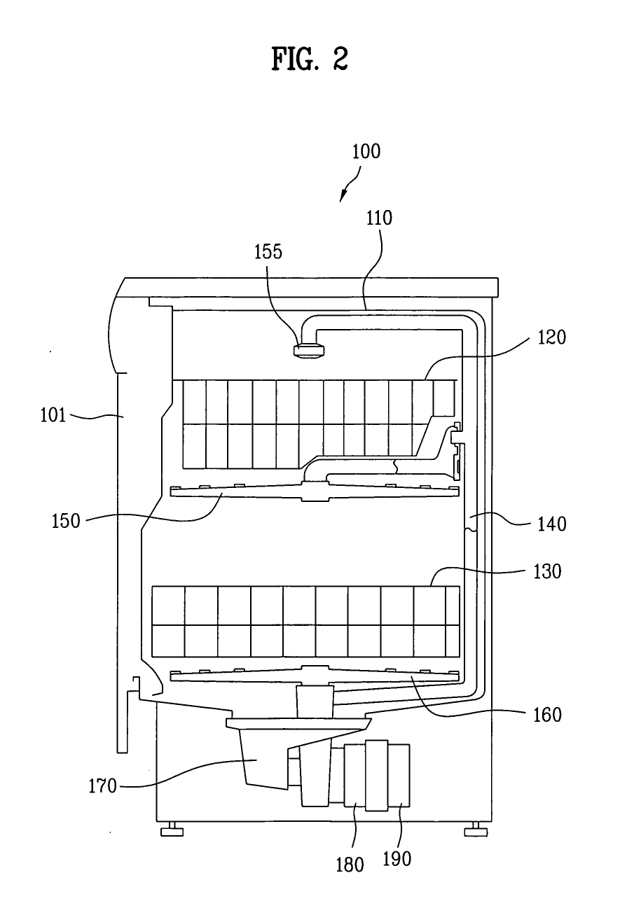

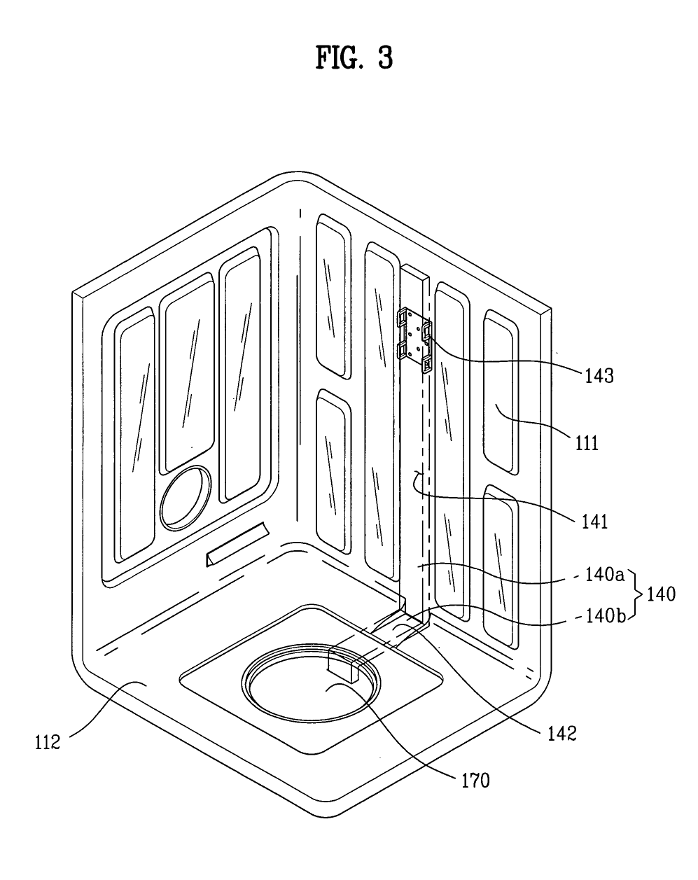

FIG. 2 is a cross-sectional view of a dishwasher according to the present invention and FIG. 3 is a schematic, perspective view illustrating an inside of a tub in a general dishwasher according to the present invention.

The dishwasher 100 of the present invention includes: a tub 110 installed in an inside of a housing; a door 101 mounted on a front side of the tub 110, for opening/closing the tub 110; and a sump 170 installed on a central portion in a bottom of the tub 110, for storing washing water.

A washing pump 180 for pumping the washing water stored in the sump 170 with a high pressure is connected with the sump 170. The washing pump 180 mounts a motor 190 for operating the washing pump 180. Further, a duct 140 which is a path through which the washing water pumped by the washing pump 180 flows is connected with the washing pump 180 through the sump 170. A lower nozzle 160 is connected with the duct 140 at a lower portion of the tub 110 to spray the washing water upward. A middle nozzle 150 is connected with the duct 140 at a central portion of the tub 110 to spray the washing water upward. A top nozzle 155 is connected with the duct 140 at an upper portion of the tub 110 to spray the washing water downward.

An upper rack 120 is mounted above the middle nozzle 150 so that the dishes may be washed by the middle nozzle 150. A lower rack 130 is mounted above the lower nozzle 160 so that the dishes may be washed by the lower nozzle 160. The washing water sprayed from the top nozzle 155 washes the dishes received in both the upper and the lower racks 120 and 130. Further, the upper and the lower racks 120 and 130 are supported by rails (not shown) provided to the inside of the tub 110 and can move back and forth so as to easily receive the dishes therein or draw the dishes therefrom.

Referring to FIG. 3, the tub 110 has a bracket 143 for supporting the duct 140. As illustrated, the duct 140 mainly includes a vertical portion 140a extended long along an inner surface 111 of a wall portion of the tub 110. Therefore, for supporting the duct 140 on the whole, the bracket 143 is attached to the inner surface 111 to support the vertical portion 140a.

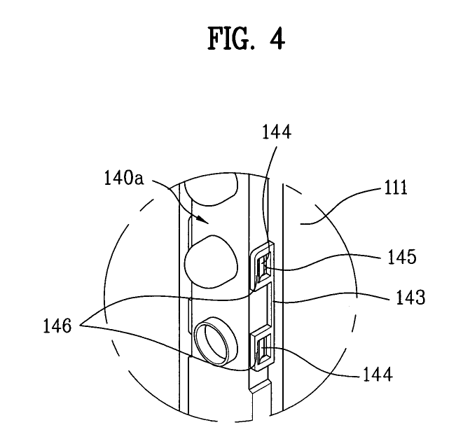

Referring to FIG. 4, the bracket 143 includes at least one flange 146 coupled to the duct 140. Accurately, the flange 146 is coupled to a side portion of the duct 140. More specifically, the duct 140 has at least one projection 144 engaged with the flange 146. Further, the flange 146 has an opening 145 into which the projection 144 is fitted. Therefore, if the duct 140 is initially pushed toward the bracket 143, the flange 146 is somewhat transformed by the projection 144. After that, if the duct 140 is pushed even more, the projection 144 is fitted into the opening 145 and engaged with the flange 146. The bracket 143 is coupled to the duct 140 by the projection 144 and the flange 146 substantially without any fastening member whatsoever. Further, the bracket 146 has the flange 146, thereby substantially supporting and enclosing the duct 140 in a stable manner. Though the bracket 143 can be coupled to the duct 140 by only one flange 146, the bracket 143 may have a pair of flanges 146 coupled respectively to both side portions of the duct 140 to more stably support the duct 140. Further, as illustrated in FIG. 4, the bracket 143 may additionally have two pairs of flanges 146 to even more stably support the duct 140.

In addition, referring to FIG. 3, the tub 110 has a recess for receiving the duct 140. The recess includes a first recess 141 formed on the inner surface 111 of the wall portion of the tub. The first recess 141 receives the vertical portion 140a of the duct 140. Thus, the bracket 143 is installed in an inside of the first recess 141 together with the vertical portion 140a. In addition, the recess further includes a second recess 142 formed on an inner surface 112 in a bottom of the tub. The second recess 142 receives a horizontal portion 140b of the duct extended along the bottom of the tub. Thus, the duct 140 can be stably supported also by the recesses 141 and 412. Further, the duct 140 may be completely received in the insides of the recesses 141 and 142 lest the duct 140 should be protruded from the recesses 141 and 142. In this manner, the duct 140 is more stably supported by the recesses 141 and 142. Further, since the duct 140 does not occupy an inner space of the tub 140, the inner space of the tub 110 is relatively increased.

As described above, the duct is stably supported by the bracket and the recesses of the present invention. Thus, the duct does not shake while the dishwasher operates and moves, so that a noise or a malfunction is not generated.

It will be apparent to those skilled in the art that various modifications and variations can be made in the present invention. Thus, it is intended that the present invention covers the modifications and variations of this invention provided they come within the scope of the appended claims and their equivalents.

1. A dishwasher comprising:
a housing;
a tub installed to an inside of the housing, for receiving dishes to be washed;
nozzles provided to an inside of the tub, for spraying washing water to the dishes;
a duct extended along an inner surface of the tub, for guiding the washing water up to the nozzles; and
a bracket attached to the tub, for supporting the duct.

2. The dishwasher of claim 1, wherein the bracket supports a vertical portion of the duct extended along an inner surface of a lateral wall of the tub.

3. The dishwasher of claim 1, wherein the bracket is attached to an inner surface of a wall of the duct.

4. The dishwasher of claim 1, wherein the bracket encloses the duct.

5. The dishwasher of claim 1, wherein the bracket comprises at least one flange coupled to the duct.

6. The dishwasher of claim 1, wherein the bracket is coupled to the duct without a fastening member.

7. The dishwasher of claim 5, wherein the flange is coupled to a side portion of the duct.

8. The dishwasher of claim 1, wherein the bracket comprises a pair of flanges coupled to both side portions of the duct.

9. The dishwasher of claim 5, wherein the duct has a projection engaged with the flange.

10. The dishwasher of claim 9, wherein the flange has an opening into which the projection is fitted.

11. The dishwasher of claim 1, further comprising a recess formed on the tub, for receiving the duct.

12. The dishwasher of claim 11, wherein the recess comprises: a first recess formed on a wall portion of the tub, for receiving a vertical portion of the duct.

13. The dishwasher of claim 11, wherein the recess comprises: a second recess formed on a bottom of the tub, for receiving a horizontal portion of the duct.

14. The dishwasher of claim 11, wherein the bracket is installed in an inside of the recess.

15. The dishwasher of claim 11, wherein the duct is not protruded from the recess.
